(19) United States
(12) Patent Application Publication
(10) Pub. No.: US 2024/0311732 A1
(43) Pub. Date: Sep. 19, 2024

(54) SYSTEM AND METHOD TO PROVIDE HUB FOR RISK MANAGEMENT TOOL

(71) Applicants: Seth J. Boutin, Burlington, CT (US); Mackenzie E. Furman, Hartford, CT (US); Richard J. Malavasi, Wethersfield, CT (US); Scott G. Parmelee, Wallingford, CT (US); Raymond Ducharme, Avon, CT (US); James T. Lessard, Wethersfield, CT (US); Ricardo A. Rhone, East Hartford, CT (US); Firoza Zahi Tai, East Hartford, CT (US); Kristen R. Wagoner, North Granby, CT (US)

(72) Inventors: Seth J. Boutin, Burlington, CT (US); Mackenzie E. Furman, Hartford, CT (US); Richard J. Malavasi, Wethersfield, CT (US); Scott G. Parmelee, Wallingford, CT (US); Raymond Ducharme, Avon, CT (US); James T. Lessard, Wethersfield, CT (US); Ricardo A. Rhone, East Hartford, CT (US); Firoza Zahi Tai, East Hartford, CT (US); Kristen R. Wagoner, North Granby, CT (US)

(21) Appl. No.: 18/185,582

(22) Filed: Mar. 17, 2023

(51) Int. Cl. G06Q 10/0635; G06Q 40/08

(52) U.S. Cl. CPC G06Q 10/0635; G06Q 40/08

(57) ABSTRACT

A risk assessment project data store contains electronic records associated with risk assessment project identifiers. For each risk assessment project identifier, the data store includes a location and associated risk coverages. A risk relationship data store contains electronic records for parties having risk relationships with an enterprise. A back-end application computer server may associate a selected risk assessment project identifier in the risk assessment project data store with a selected party having a risk relationship with the enterprise. The computer server may then receive from a user an adjustment to at least one of the location and risk coverages associated with the selected risk assessment project identifier. A risk analysis is automatically performed based on the adjusted location and risk coverages along with information retrieved from the risk relationship data store and the risk assessment project data store can then be updated with a result of the risk analysis.

### TECHNICAL FIELD

The present application generally relates to computer systems and more particularly to computer systems that are adapted to accurately, securely, and/or automatically manage risk assessment projects for a risk relationship enterprise.

### BACKGROUND

An enterprise may enter into relationships with various parties. For example, an insurer might enter into risk relationships (e.g., insurance agreements) with various businesses. In some cases, the risk relationship may be associated with catastrophe insurance that covers low-probability, high-cost events such as natural disasters (e.g., earthquakes, floods, and hurricanes and human-made disasters (e.g., a riot or terrorist attack). Catastrophe hazard assessment and pricing models are constantly being enhanced to improve protection and reduce earnings volatility. These models may be important to help ensure adequate pricing and prevent adverse selection. It may therefore be desirable to leverage these ongoing enhancements and ensure timely incorporation into the overall underwriting process.

It would be desirable to provide improved systems and methods to accurately and/or automatically provide risk analysis and management tools for an enterprise. Moreover, the results should be easy to access, understand, interpret, update, etc.

### SUMMARY OF THE INVENTION

According to some embodiments, systems, methods, apparatus, computer program code and means are provided to accurately and/or automatically provide risk management tools for an enterprise in a way that provides fast, secure, and useful results and that allows for flexibility and effectiveness when responding to those results.

Some embodiments are directed to a risk management implemented via a back-end application computer server. A risk assessment project data store contains electronic records associated with risk assessment project identifiers. For each risk assessment project identifier, the data store includes a location and associated risk coverages. A risk relationship data store contains electronic records for parties having risk relationships with an enterprise. A back-end application computer server may associate a selected risk assessment project identifier in the risk assessment project data store with a selected party having a risk relationship with the enterprise. The computer server may then receive from a user an adjustment to at least one of the location and risk coverages associated with the selected risk assessment project identifier. A risk analysis is automatically performed based on the adjusted location and risk coverages along with information retrieved from the risk relationship data store and the risk assessment project data store can then be updated with a result of the risk analysis.

Some embodiments comprise: means for associating, by a computer processor of a back-end application computer server, a selected risk assessment project identifier in a risk assessment project data store with a selected party having a risk relationship with an enterprise, wherein the risk assessment project data store contains electronic records associated with a plurality of risk assessment project identifiers, and, for each risk assessment project identifier, a party identifier, a location, and associated risk coverages; means for receiving from a user an adjustment to at least one of the location and risk coverages associated with the selected risk assessment project identifier; means for automatically performing a risk analysis based on the adjusted location and risk coverages along with information retrieved from the risk relationship data store in accordance with the party identifier of the selected party, wherein the risk relationship data store contains electronic records associated with a plurality of parties having risk relationships with the enterprise, and, for each party, a party identifier and risk relationship parameters; means for updating the risk assessment project data store with a result of the risk analysis; and means for exchanging data with a remote device to support interactive user interface displays that include information about the result of the risk analysis.

In some embodiments, a communication device associated with a back-end application computer server exchanges information with remote devices in connection with interactive graphical user interfaces. The information may be exchanged, for example, via public and/or proprietary communication networks.

A technical effect of some embodiments of the invention is improved and computerized risk management for an enterprise that provide fast, secure, and useful results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 shows various enterprise risk relationships according to some embodiments.

FIG. 2 is a high-level block diagram of a risk management system in accordance with some embodiments.

FIG. 3 illustrates a high-level method according to some embodiments.

FIG. 4 is a risk assessment project display in accordance with some embodiments.

FIG. 5 is a new project display according to some embodiments.

FIG. 6 is a policy details display in accordance with some embodiments.

FIG. 7 is a locations display according to some embodiments.

FIG. 8 is an edit project display in accordance with some embodiments.

FIG. 9 is a peril request display according to some embodiments.

FIG. 10 is an all peril results display on a tablet computer in accordance with some embodiments.

FIG. 11 is a terrorism results display according to some embodiments.

FIG. 12 is a location epicenter display in accordance with some embodiments.

FIG. 13 is a risk visualization display according to some embodiments.

FIG. 14 is a wildfire scoring results display in accordance with some embodiments.

FIG. 15 is a promote locations display according to some embodiments.

FIG. 16 is a services display in accordance with some embodiments.

FIG. 17 is a services drop down menu display according to some embodiments.

FIG. 18 is an average annual loss display in accordance with some embodiments.

FIG. 19 is a distance to coast selection display according to some embodiments.

FIG. 20 is a distance to coast data entry display in accordance with some embodiments.

FIG. 21 is another distance to coast display on a smartphone according to some embodiments.

FIG. 22 is an earthquake hazard selection display in accordance with some embodiments.

FIG. 23 is an earthquake hazard report tool display according to some embodiments.

FIG. 24 is a hazard rating selection display in accordance with some embodiments.

FIG. 25 is a hazard rating display according to some embodiments.

FIG. 26 is an exposure reports selection display in accordance with some embodiments.

FIG. 27 is an exposure report drop down menu display according to some embodiments.

FIG. 28 is a more detailed system according to some embodiments.

FIG. 29 is a block diagram of an apparatus in accordance with some embodiments.

FIG. 30 is a portion of a tabular risk assessment project database according to some embodiments.

FIG. 31 is a portion of a tabular insurance policy database according to some embodiments.

FIG. 32 is an operator or administrator display in accordance with some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data processing associated with risk management. The present invention is directed to more than merely a computer implementation of a routine or conventional activity previously known in the industry as it provides a specific advancement in the area of electronic record analysis by providing improvements in the operation of a computer system that customizes risk management (including those associated with risk relationships). The present invention provides improvement beyond a mere generic computer implementation as it involves the novel ordered combination of system elements and processes to provide improvements in the speed, security, and accuracy of such a risk management tool for an enterprise. Some embodiments of the present invention are directed to a system adapted to automatically customize and execute risk management, aggregate data from multiple data sources, automatically optimize location and coverage information to reduce unnecessary messages or communications, etc. (e.g., to consolidate risk data). Moreover, communication links and messages may be automatically established, aggregated, formatted, modified, removed, exchanged, etc. to improve network performance (e.g., by reducing an amount of network messaging bandwidth and/or storage required to create risk management messages or alerts, improve security, reduce the size of a risk assessment project data store, more efficiently collect hazard data, etc.).

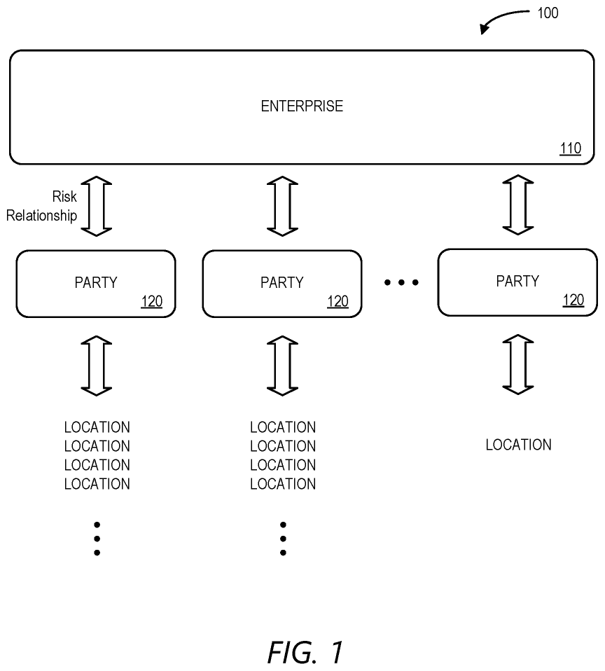

FIG. 1 shows various enterprise risk relationships 100 according to some embodiments. In particular, an enterprise 110, such as an insurance company, may have risk relationships (e.g., insurance agreements or policies) associated with parties 120 (such as employers). For example, an insurance company may offer catastrophe insurance to businesses. Each party 120 might be associated with one or more locations (e.g., various offices throughout the country).

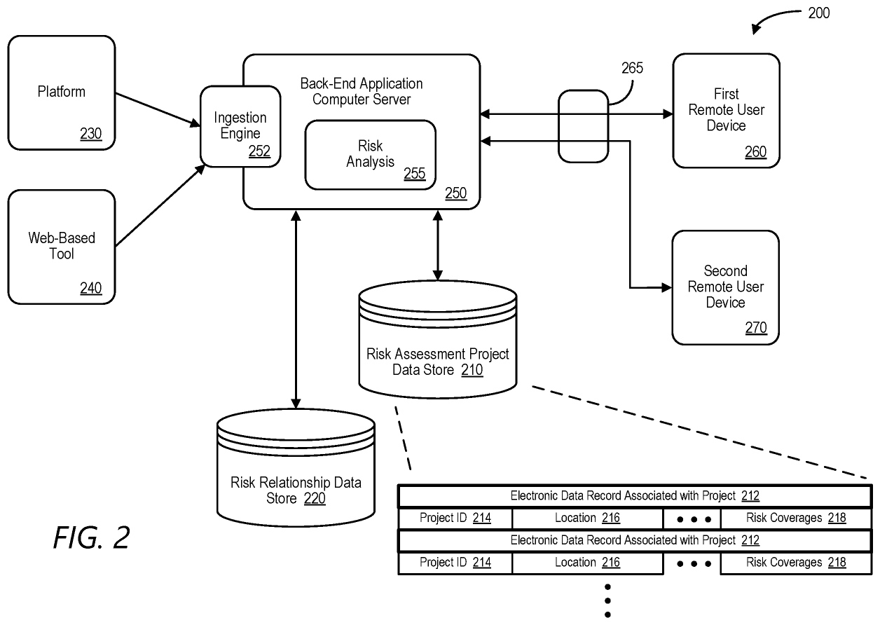

FIG. 2 is a high-level block diagram of a risk management system 200 that may be provided according to some embodiments of the present invention. In particular, the system 200 includes a back-end application computer server 250 that may access information in a risk assessment project data store 210 (e.g., storing a set of electronic records associated with various risk assessment projects 212, each record including, for example, one or more risk assessment project identifiers 214, locations 216, risk coverages 218, etc.). The back-end application computer server 250 may also store information into other data stores, such as a risk relationship data store 220, and utilize an ingestion engine 252 and risk analysis algorithm 255 to exchange and process messages (e.g., daily/weekly data sweeps or on-demand changes) and view, analyze, and/or update the electronic records. The back-end application computer server 250 may also exchange information with a first remote user device 260 and a second remote user device 270 (e.g., via a firewall 265). According to some embodiments, an interactive graphical user interface platform of the back-end application computer server 250 may facilitate risk management, recommendations, alerts, and/or the display of results via one or more remote administrator computers (e.g., to summarize system 200 performance) and/or the remote user devices 260, 270. For example, the first remote user device 260 may transmit annotated and/or updated information to the back-end application computer server 250. Based on the updated information, the back-end application computer server 250 may adjust data in the risk assessment project data store 210 and/or the risk relationship data store 220 and the change may (or may not) be used in connection with the second remote user device 270 (e.g., depending on whether the two users are associated with the same enterprise or entity). Note that the back-end application computer server 250 and/or any of the other devices and methods described herein might be associated with a third party, such as a vendor that performs a service for an enterprise.

In some cases, the ingestion engine 252 may receive information from one or more platforms 230 and/or web-based tools 240. For example, property catastrophe hazard assessment and pricing models may be constantly enhanced to improve protection and reduce earnings volatility. To leverage these ongoing enhancements and ensure timely incorporation into an underwriting process, a modular architecture may deliver these capabilities directly through underwriting systems for larger businesses via a platform 230 and/or by way of the standalone web-based tool 240 for smaller business units or complex risks requiring more comprehensive underwriting.

The back-end application computer server 250 and/or the other elements of the system 200 might be, for example, associated with a Personal Computer (“PC”), laptop computer, smartphone, an enterprise server, a server farm, and/or a database or similar storage devices. According to some embodiments, an “automated” back-end application computer server 250 (and/or other elements of the system 200) may facilitate the automated access and/or update of electronic records in the data stores 210, 220 and/or the management of a risk assessment project. As used herein, the term “automated” may refer to, for example, actions that can be performed with little (or no) intervention by a human.

Devices, including those associated with the back-end application computer server 250 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 250 may store information into and/or retrieve information from the risk assessment project data store 210 and/or the risk relationship data store 220. The data stores 210, 220 may be locally stored or reside remote from the back-end application computer server 250. As will be described further below, the risk assessment project data store 210 may be used by the back-end application computer server 250 in connection with an interactive user interface to access and update electronic records. Although a single back-end application computer server 250 is shown in FIG. 2, any number of such devices may be included. Moreover, various devices described herein might be combined according to embodiments of the present invention. For example, in some embodiments, the back-end application computer server 250 and risk assessment project data store 210 might be co-located and/or may comprise a single apparatus.

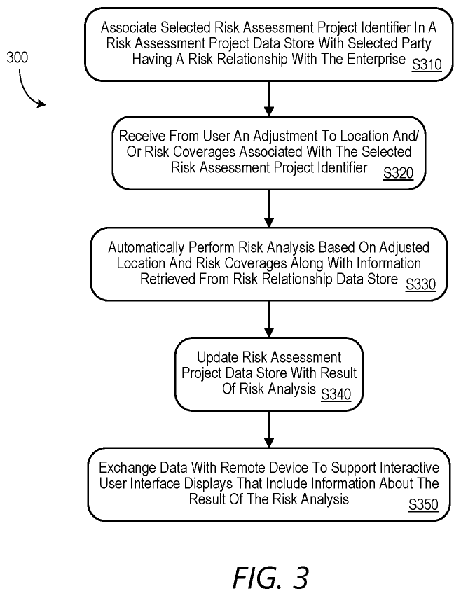

The elements of the system 200 may work together to perform the various embodiments of the present invention. Note that the system 200 of FIG. 2 is provided only as an example, and embodiments may be associated with additional elements or components. According to some embodiments, the elements of the system 200 automatically transmit information associated with an interactive user interface display over a distributed communication network. FIG. 3 illustrates a method 300 that might be performed by some or all of the elements of the system 200 described with respect to FIG. 2, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a computer processor of a back-end application computer server may associate a selected risk assessment project identifier in a risk assessment project data store with a selected party that has a risk relationship with an enterprise. The risk assessment project data store may, for example, contain electronic records for a plurality of risk assessment project identifiers (and, for each risk assessment project identifier, a party identifier, a location, and associated risk coverages). The risk relationship might represent, for example, an existing risk relationship, a risk relationship renewal, a potential future risk relationship, etc. In some cases, a plurality of locations may be included for a single party identifier. Moreover, the risk relationship between the selected party and the enterprise may represent catastrophe insurance (e.g., associated with terrorism, wildfires, earthquakes, hurricanes, tornados and hail, winter storms, floods, landslides, sink holes, volcanos, etc. The risk coverages might be associated with, for example, a property insurance policy, a workers' compensation insurance policy, a group benefits insurance policy, etc. In addition, the risk coverages may include an aggregate limit value, an aggregate deductible value, volume values, etc.

At S320, the system may receive from a user an adjustment to at least one of the location and risk coverages associated with the selected risk assessment project identifier. At S330, a risk analysis is automatically performed based on the adjusted location and risk coverages along with information retrieved from a risk relationship data store in accordance with the party identifier of the selected party. The risk relationship data store may, for example, contain electronic records associated with a plurality of parties having risk relationships with the enterprise (and, for each party, a party identifier and risk relationship parameters). Moreover, the risk analysis might be associated with a hazard assessment and/or a pricing model. At S340, the risk assessment project data store is updated with a result of the risk analysis. The result of the risk analysis might be associated with, for example, an average annual loss, a distance to coast, a hazard rating, a hazard exposure report, etc. At S350, the system may exchange data with a remote device to support interactive user interface displays that include information about the result of the risk analysis.

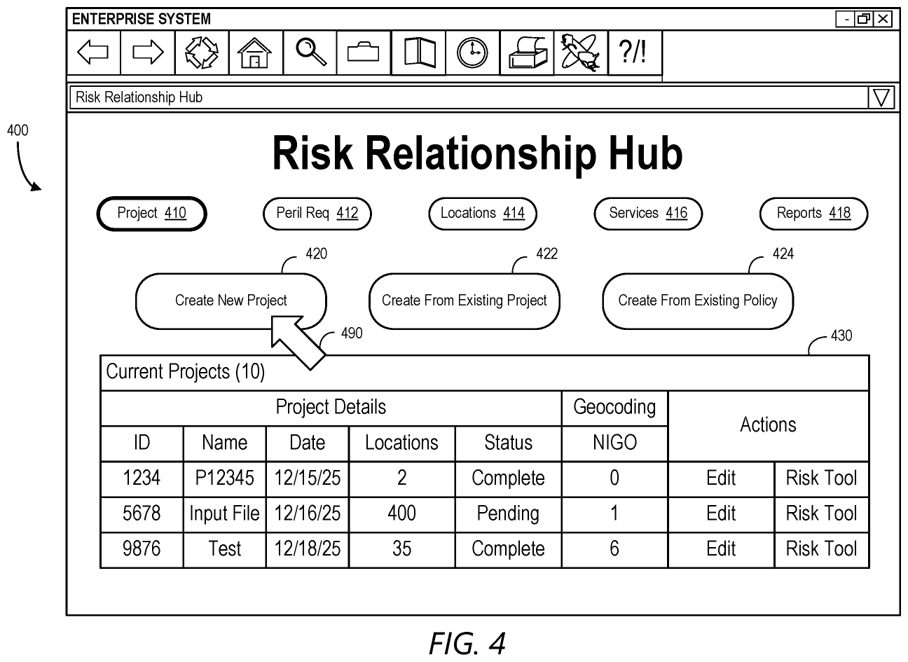

According to some embodiments, a back-end application computer server uses the concept of “Projects” to organize and store information for users. Projects may, for example, be used to store all input details such as insurance policy, business, locations and coverage data (as well as to run peril analysis). Each project may be created with a project name that is intuitive to an end user to help them understand what has been run. FIG. 4 is a risk assessment project display 400 in accordance with some embodiments. The display 400 lets a user navigate between a project 410 page or tab, a peril request 412 page, a locations 414 page, a services 416 page, and a reports 418 page. The project 410 page is the main organizational display 400 within the hub that lets a user create a new project 420, bring in new information for analysis, and/or open an existing project 422 (e.g., to modify policy/location information and then obtain analysis results. The user can also bring the data from an existing insurance policy into a project 424.

This display 400 will also show a user's projects in a grid 430 (e.g., with the most recent projects at the top of the grid 430). The grid 430 might include, for example, a project identifier, a project name, a creation date, a location, a status, etc. In some embodiments, users can edit, view, copy, export, and/or delete projects from the display 400 (e.g., via a touchscreen selection or compute pointer 490) as well as open the project in a risk visualization application. According to some embodiments, users can also filter and sort projects in their project list grid 430.

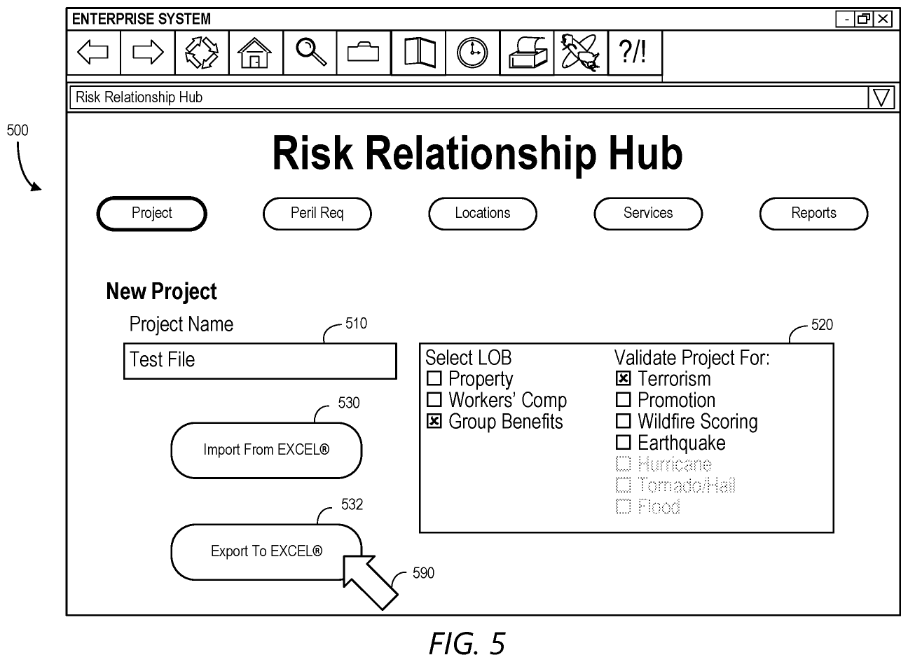

There may be different ways to create a new project, each being represented by an icon or button 420, 422. 424 at the top of the display 400 (or from a drop down list if the pointer 490 hovers over the project 410 icon. When the “Create New Project” 420 icon is selected, a user can create a new project from external data (either manually typing in the policy and location level information about a potential policy or importing the information from a spreadsheet application using a template). For example, FIG. 5 is a new project display 500 according to some embodiments. Here, a user can enter a project name 510 along with Lines Of Business (“LOB”) and validation information 520. Note that a single project request for the automatic performance of a risk analysis may generate multiple results, each result being associated with a different type of risk (e.g., a terrorism report, an earthquake analysis, etc.). Moreover, the user can select an “Import from EXCEL®” 530 icon or an “Export to EXCEL®” 532 icon (e.g., via a touchscreen or pointer 590). In some embodiments, a risk analysis is performed based on a particular project. Moreover, in some embodiments, a risk analysis may be performed based on information from a spreadsheet application file (e.g., the “Import from EXCEL®” 530 icon). Using project-based information may improve consistency between various types of analysis and/or reports, reduce unintended errors, etc.

If the “Create from Existing Project” 422 icon was selected from the risk assessment project display 400, a user can search the hub for an already created project. This allows for collaboration between users, letting one user search for another's projects using a project identifier, project name or user identifier. Moreover, a user may select to view, copy, or export the details of the project from the search results. When the user chooses to copy, it will create a new copy of that project (and any modifications will not overwrite the original user's project.) Selecting to view a project may open the project in a “read only” mode (and not allow them to edit the data). Selecting to export a project may let users export the input data from the original project into a spreadsheet file (e.g., a xlsx file).

If the “Create from Existing Project” 422 icon was selected from the risk assessment project display 400, a user can search the in-force insurance policy database for existing policies and create a project that is pre-filled using data already in the database. Once pulled from the database, the information can be edited within the new project. This can may be useful, for example, to preload data during a renewal when most information will remain the same.

If user is creating a new project from scratch, they will have two options to create the project. They can import the data via an excel spreadsheet or enter the data manually in hub project page. When a user clicks on the “Import From EXCEL®” 530 icon on the new project display 500, the hub will ask the user to browse to the EXCEL® sheet that they are expecting to load. The spreadsheet may need to be in an appropriate format; a template can be downloaded from a link provided below the “Import from EXCEL®” 530 icon. The template might have multiple tabs with the first two tabs being used for input data. For example, the first tab may be for policy level information and the second for location level information. Within the EXCEL® template, documentation may be provided about what each field means. Note that these may be the same fields that appear on the hub project screen which will be filled in with the appropriate information when an EXCEL® file is imported.

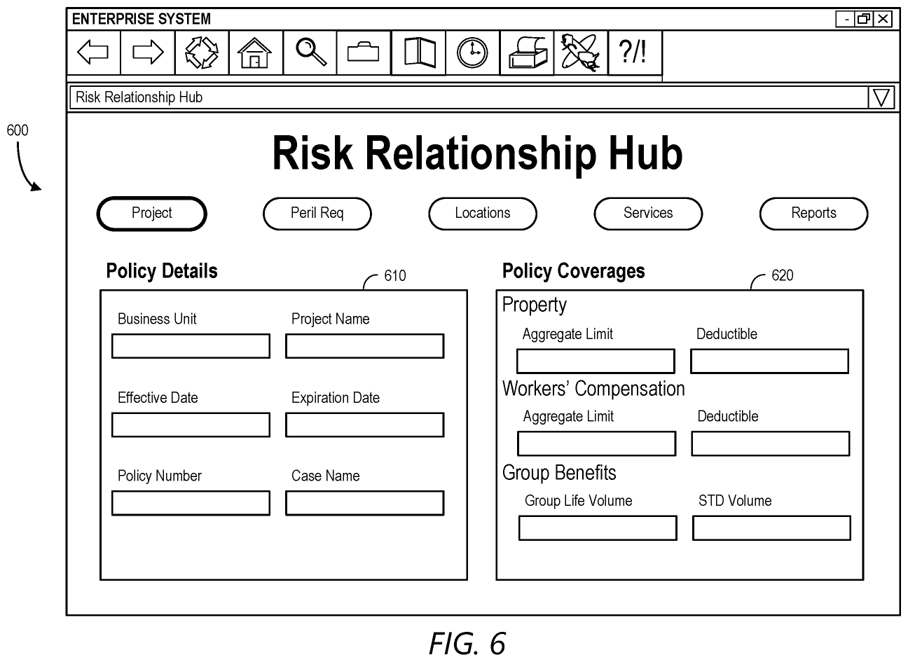

According to some embodiments, a user has the ability to manually type in all of the associated information for an account they wish to analyze directly into the hub project form. For example, FIG. 6 is a policy details display 600 in accordance with some embodiments. The display 600 includes policy details 610 and policy coverages 620. A user may first type in the project name at the top of the policy details 610 (along with a business unit, policy dates, policy numbers, etc.) and choose what type of an account it is selecting any combination of policy coverages 620 (e.g., property, workers' compensation, and group benefits). Note that different types of policy coverages 620 may have different types of data (e.g., property and workers' compensation might have aggregate limits and aggregate deductibles while group benefits has volume values for Sort Term Disability (“STD”) Long Term Disability (“LTD”)). According to some embodiments, choosing the type of account may unhide the input fields that are unique to each type of business that could be populated by the user. The user can also indicate how the project will be validated so that the hub can guide them about the required fields for the intended use of the project.

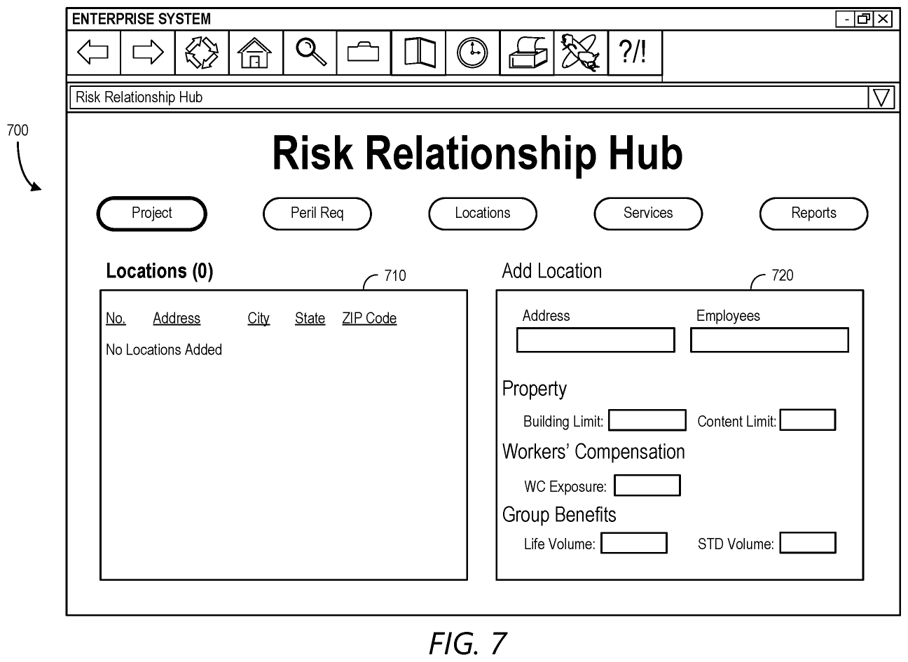

After a user has filled in the policy level information, they can input location level information. For example, FIG. 7 is a locations display 700 according to some embodiments. The locations list 710 may be shown on the left side of the display 700 with a number, address, city, state, and ZIP code. The list may start out as empty for new projects (or be automatically populated if the project was loaded from an EXCEL® file, existing policy, or existing project). To add a new location 720, a user may enter information to the right side of the display 700. Once a user enters minimally a location's address, city, state, and ZIP they can save a location to the project by clicking on a save icon; though in order to get accurate results, location level coverages should also be entered. After each location is added, the location list 710 on the left side of the display 700 will be updated. To add additional locations, a user can use a “plus” icon. User can also go back and edit location by clicking on the row for the given location in the list 710, making updates, and then selecting the save icon. A location can also be deleted by selecting the row for the location from the list 710 and clicking on a “trash” icon. The user can enter all of the details for each location that they want to include in the analysis (employee count, payroll amounts, etc.). When the user is done entering project information, they may select a “Save Project” icon at the bottom of the screen.

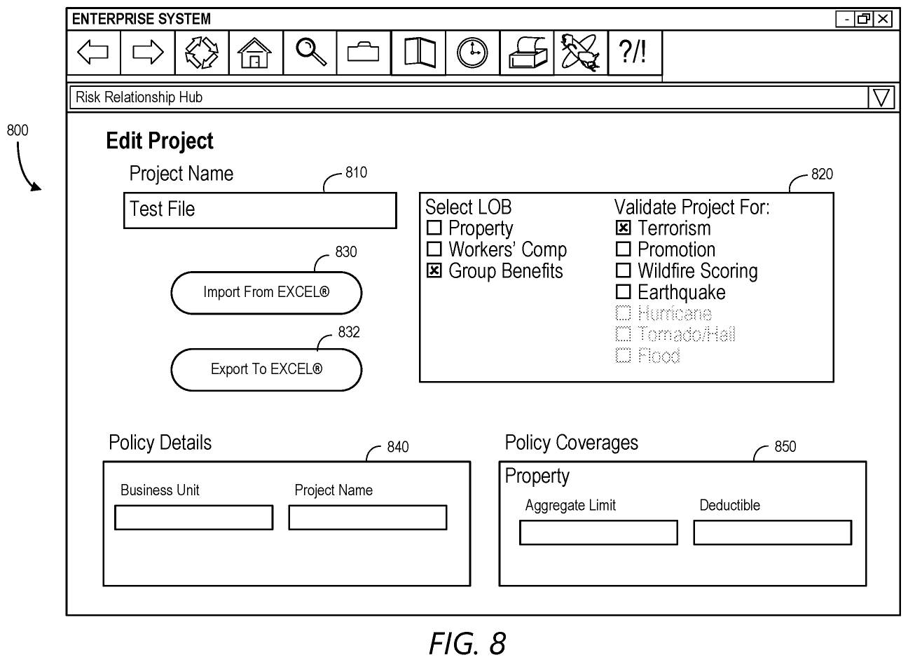

Once a project is created, it will be added to the “Current Projects” grid 430 displaying high-level information about the project. From here, the projects can be edited by clicking on the “Edit” button. For example, FIG. 8 is an edit project display 800 in accordance with some embodiments. The edit project display 800 lets a user update and store information associated with an account that they want to analyze. The user may enter a project name 810 and select LOB and project validation selection 820. When a user clicks on the “Import From Excel” 830 icon on the edit project display 800, the hub will ask the user to browse to the EXCEL® sheet that they are expecting to load. The imported information may replace the information currently in the project. The user also has the ability to manually adjust the policy details 840 and policy coverages 850 for the project. The user can also use an “Export to EXCEL®” 832 icon to export the details of the project into a spreadsheet (e.g., to do a bulk update if necessary). The data may be exported into the same format as the input template to make it easy to re-import the information into a new project.

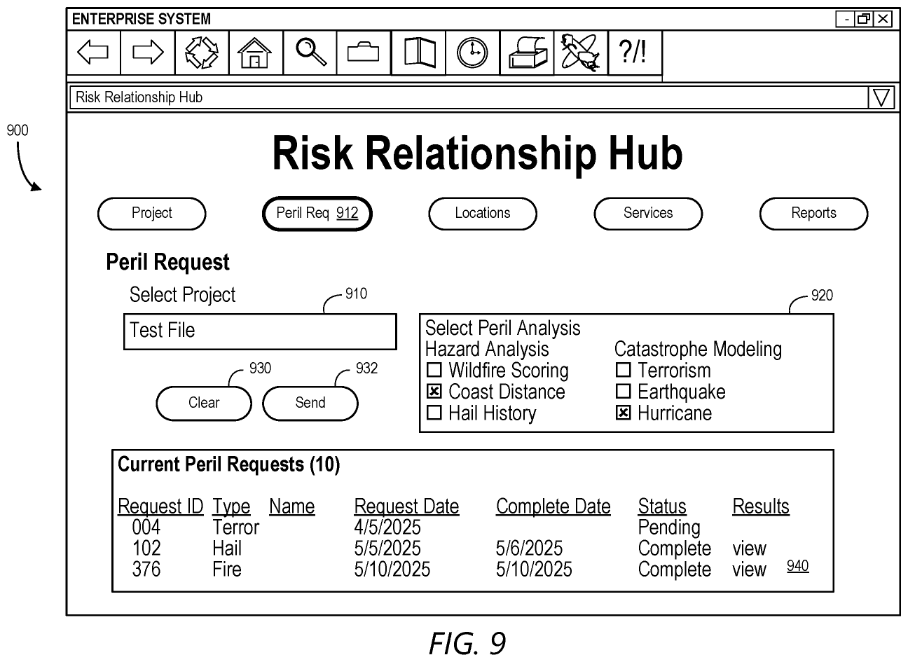

After the user has a saved project that was manually entered, imported from an EXCEL® sheet, created from an existing project (or existing policy), etc., it is available for risk analysis. For example, terrorism Probably Maximum Loss (“PML”) calculations and wildfire scoring may be available. To run the analyses, users may access a peril request page. For example, FIG. 9 is a peril request display 900 selected via a “Peril Request” 912 navigation icon or tab. The display 900 lets the user select any project that they have saved (e.g., via a select project 910 field) and run different analyses 920. A “Clear” 930 may let the user re-start the data entry process. The user might, for example, choose the project they wish from a drop down list and select the peril analyses 920 (note that multiple can be run in a single request) they want to run and click a “Send” 932 icon.

The hub tool will then submit a request and user will see a current peril requests table grid 940 update with the status of the whole request. The request status might change to “Processing” and then “Complete” or “Complete with Failure.” If a user prefers to see the status of an individual portion of the request (e.g., only the terrorism portion of a request) they can expand the row in the grid 940 to see the individual statuses of each portion of the request (which might show “Processing” and then “Success” or “Failed”). The peril request display 900 allows a user to run analyses on multiple projects or perils at the same time with minimal interaction. Once the request is submitted, a user can choose to wait for the results or (if the account is large or multiple perils are being run) they can close the page and come back to view the results after they are finished. Once any of the analyses in the request are complete (and the request status is “Success”), the user will be able to see the results by clicking on a “view” button or link. If the user chooses to click “view” on an individual peril within a request, it will bring them directly to that peril results page. However, if a user clicks to view the results of the whole analyses request, it will bring the user to an account summary page. According to some embodiments, users can also filter and sort requests in the peril requests grid 940.

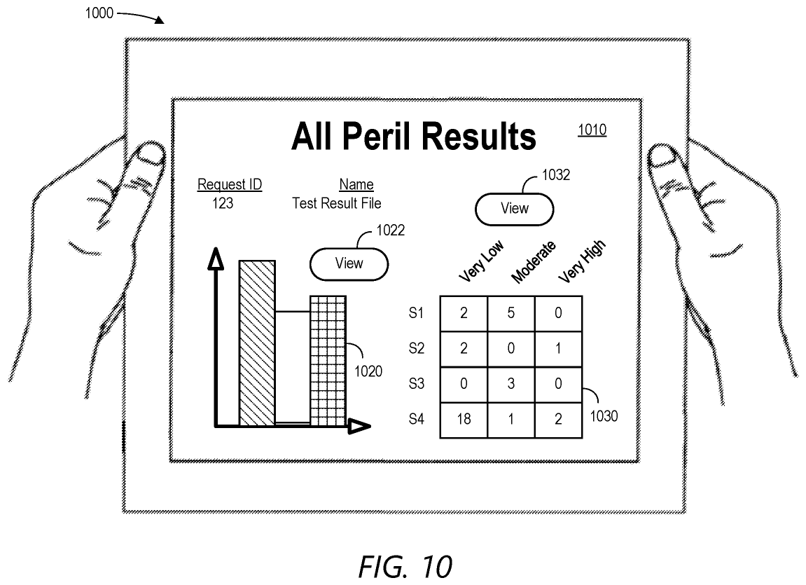

FIG. 10 is an all peril results display 1010 for multiple analyses shown on a tablet computer 1000 in accordance with some embodiments. In particular, the display 1010 includes results for terrorism 1020 and wildfire 1030. The display 1010 show the highlights of the analyses so that a user can get a first glance of how the account looks in terms of risk. In each result 1020, 1030 you can view the complete results of the analysis by clicking a “View” 1022, 1032 icon. Additionally, in some embodiments a user can export all of the results using an “Export to EXCEL®” icon.

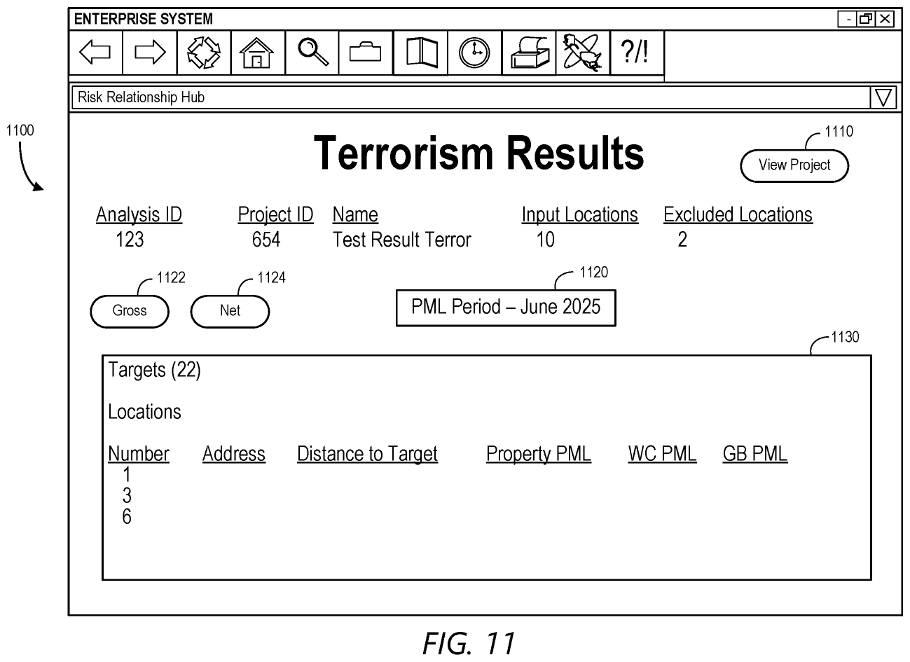

If the user clicks on the “View” icon 1022 to review the analysis results for terrorism specifically, a terrorism results page will show the terrorism metrics for the selected project. For example, FIG. 11 is a terrorism results display 1100 according to some embodiments. The display 1100 lets a user return to the all perils project-level view 1110 and covers a PML time period 1120. A targets 1130 section lets a user see every managed terrorism target that the project they ran would contribute to PML. Each individual managed target has a line with the total PML increase that the project would contribute to the target. In addition to the increased PML values, display 1100 also communicates the target's current ratings and changes in ratings to the user. According to some embodiments, a “+” lets the user expand and see the details about how each location in their project individually contributed to the total PML. According to some embodiments, a location epicenter may contain epicenter results for the given locations (excluded locations may show locations that were not included in the PML results, such as NIGO locations). The PML results are displayed for Gross and Net calculation and can be viewed by toggling on “Gross” 1122 or “Net” 1124 icons.

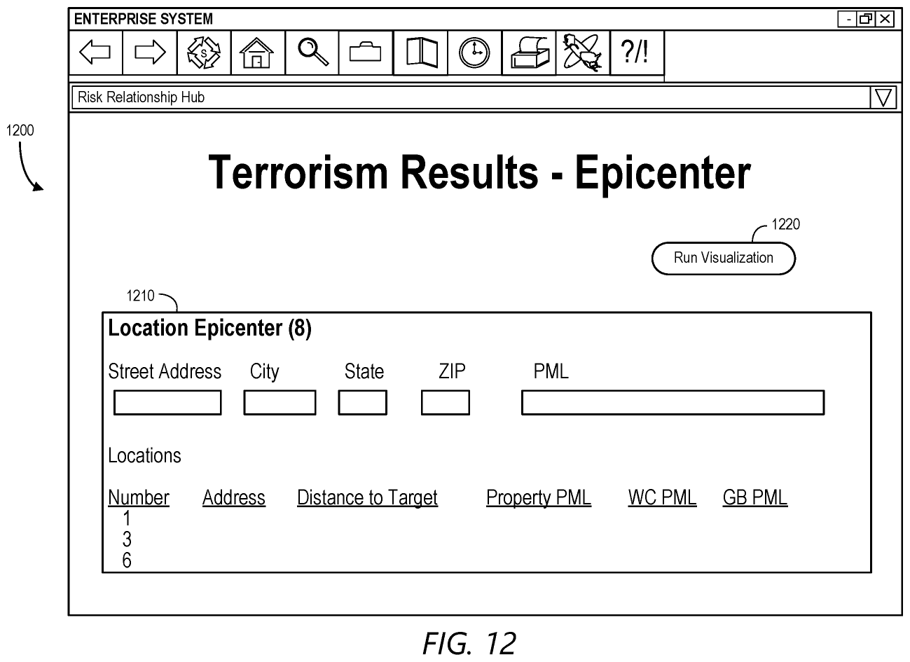

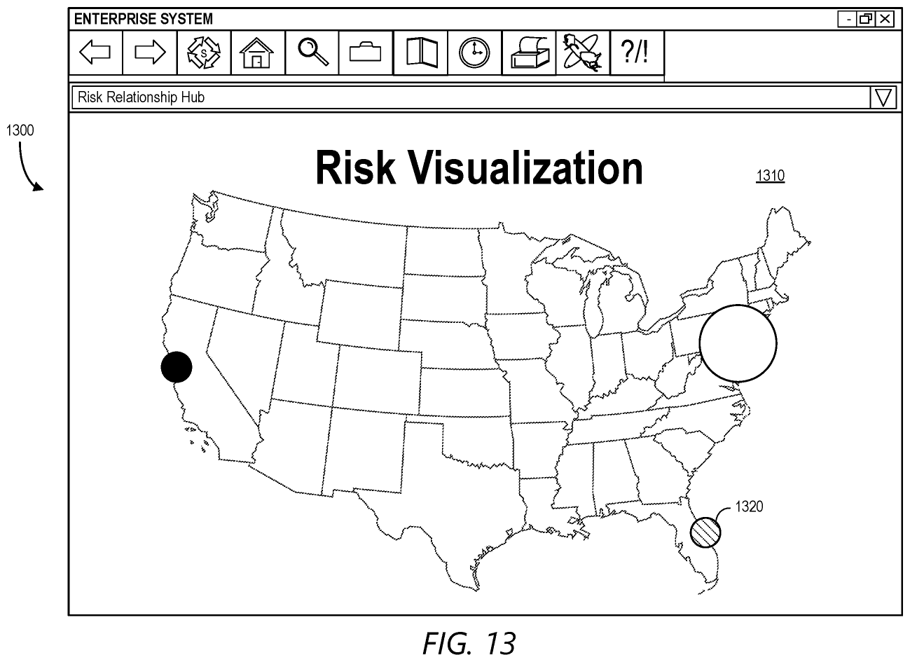

FIG. 12 is a location epicenter display 1200 in accordance with some embodiments. A location epicenter portion 1210 communicates to the user the PML value at each of the input locations for the project. These values can be used to analyze if a project's locations could potentially breach certain enterprise limits or become a managed target in future updates. A user can also view these locations in a risk visualization application with information about the PML values and ratings by clicking on a “Run Visualization” 1220 icon. In some embodiments, there is a “+” icon that lets the user expand and see the details of how each location in their project individually contributed to the location epicenter and PML values for of each of those locations. When the “Run Visualization” 1220 icon is selected, it opens a risk visualization application in a new window displaying a map with locations plotted and a grid with locations, PML values, rating details, etc. For example, FIG. 13 is a risk visualization display 1300 with a map 1310 and icons 1320 that are associated with PML values and/or locations according to some embodiments. In some embodiments, the terrorism information can be exported using an “Export to EXCEL®” icon. This lets the user download the results into a spreadsheet with both the target, epicenter, and excluded locations results.

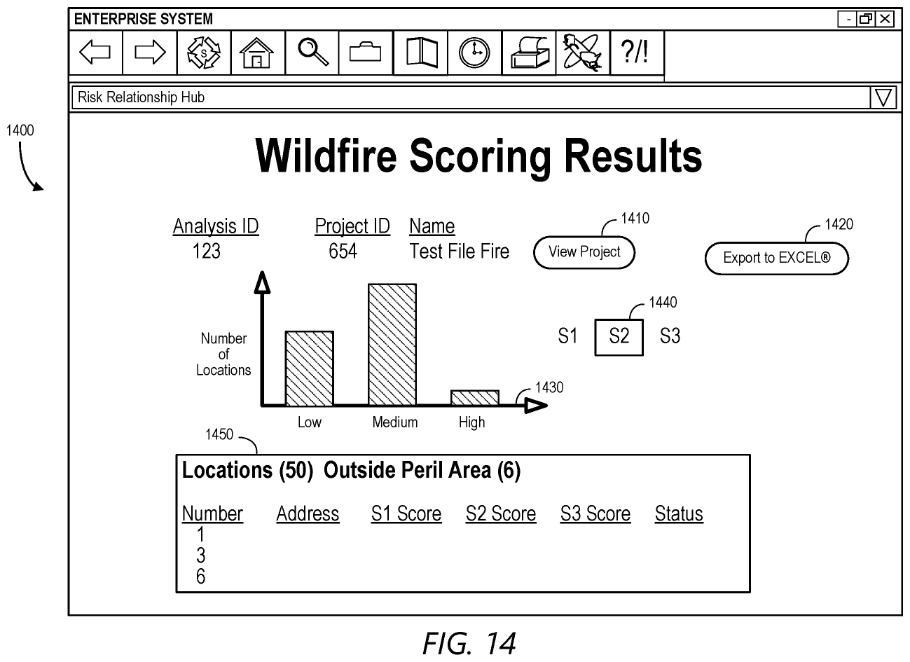

When a user clicks on the “View” 1032 icon for wildfire scoring specifically it brings the user to the wildfire scoring results page. For example, FIG. 14 is a wildfire scoring results display 1400 in accordance with some embodiments. A graph 1430 shows how many locations are assigned to various risk levels. The graph 1430 be toggled 1440 to see the distribution of either the S1, S2, or S3 scores by description for the locations within the user's project. Below the graph is a grid 1450 that will display the full details for each location with the S1, S2, and S3 scores each recorded. The description associated with each score is also included for every location. In some embodiments, the range of scores for the different description categories can be viewed by clicking on an information icon. The grid 1450 can be sorted or filtered as desired and can also be exported to excel by clicking the “Export to EXCEL®” 1420 icon. A “View Project” 1410 icon will return the user to the all peril results page.

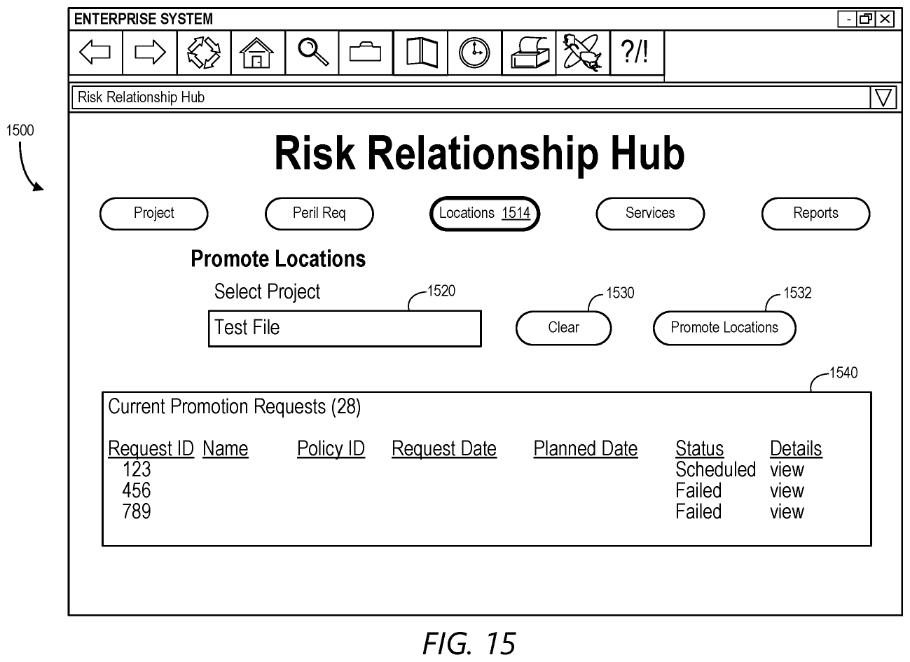

FIG. 15 is a promote locations display 1500 accessed via a “Locations” 1514 icon or tab according to some embodiments. Note that the hub may include the capability for workers' compensation users who utilize a national accounts database and group benefits users to promote location level account details to an enterprise repository for terrorism monitoring purposes (e.g., because some front-end systems might not capture location level). In order to promote a project to an enterprise database, the project should have all appropriate information stored for each location and the project should be saved. Once saved, a user can click on the “Promote Locations” 1532 icon (or “Clear” 1530 the current selection). The display 1500 lets a user choose the saved project from a “Select Project” 1520 drop down list and click the “Promote Locations” 1532 icon. Once this is complete, the project will appear in the promotion requests grid 1540 showing project/policy/request details including the date of request as well as a scheduled (or planned) date (e.g., if the promotion cycle happens once per week). The grid 1540 may also let user see the details of the changes by clicking on the “View” link in the details column of the grid 1540. The user can also filter and sort projects in the requests grid 1540.

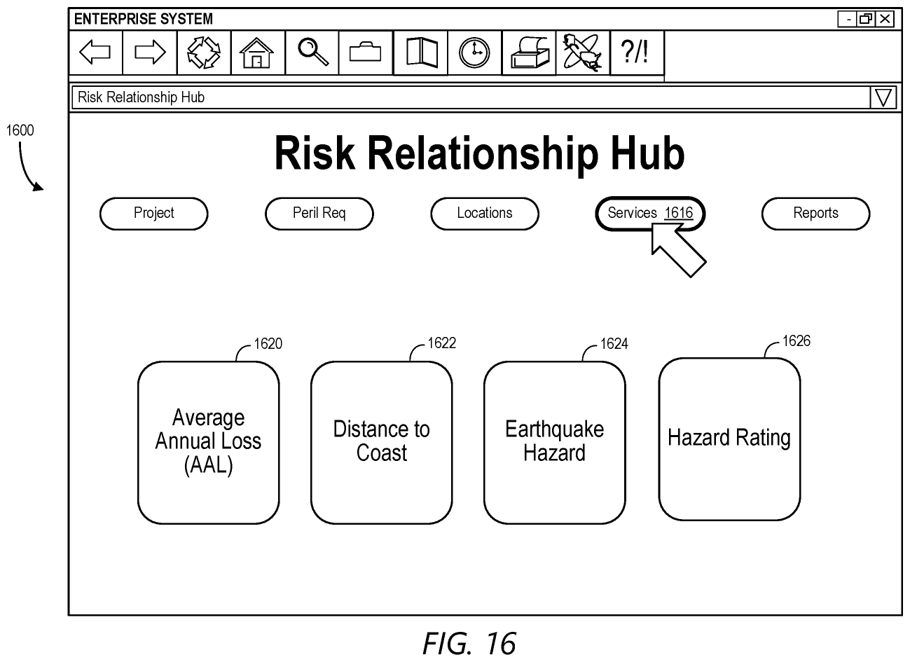

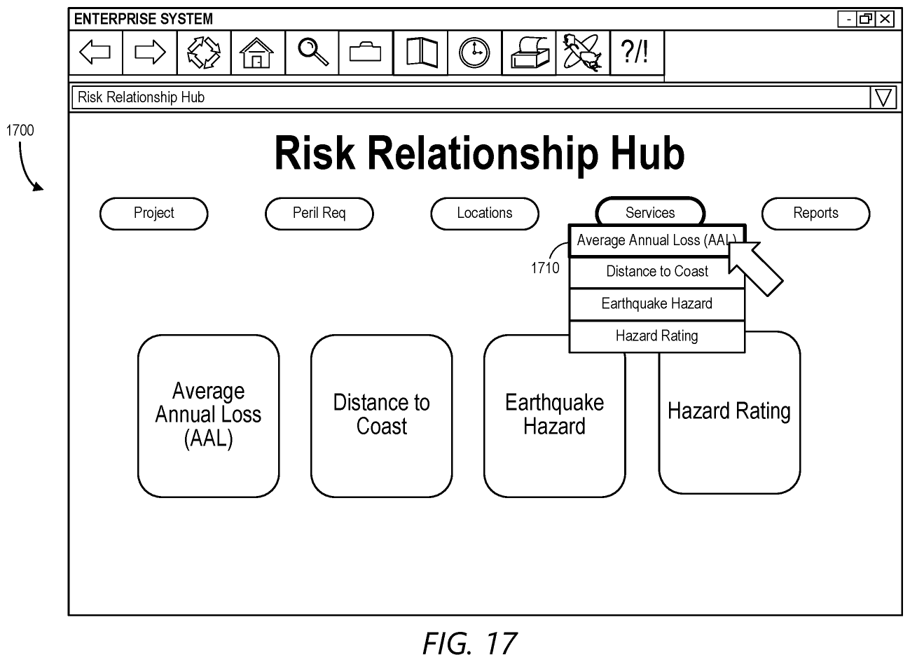

FIG. 16 is a services display 1600 that can be accessed by a “services” 1616 icon or tab in accordance with some embodiments. Note that in some embodiments, additional hazard analysis may be fully embedded into the project concept of the hub. In other embodiments, the additional hazard analysis tool might instead be implemented as a separate link to request the associated information for Average Annual Loss (“AAL”) 1620, distance to coast 1622, earthquake hazard 1624, and hazard rating 1626. In some embodiments, these selections are also found under the “Services” icon 1616. For example, FIG. 17 is a services drop down menu 1710 display 1700 according to some embodiments. In some embodiments, these analyses can be done prior to entering any project information into the hub (because as it will have a separate location input method and does not share the project information). Note that input templates may be used to support services. For example, a template may be downloaded from the services page for AAL, distance to coast, earthquake hazard, and/or hazard rating services.

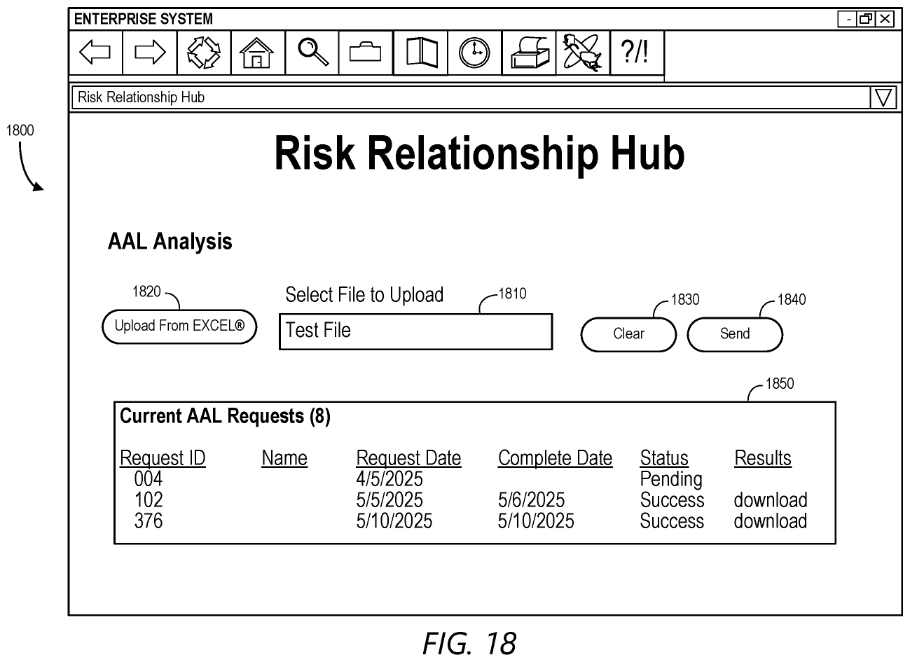

FIG. 18 is an average annual loss display 1800 for catastrophe modeling analysis in accordance with some embodiments. The display 1800 lets users who are analyzing a property account utilize the risk relationship hub to send a modeling request to a catastrophe risk modeling platform to obtain account and location level AAL and/or PML values for various return periods and perils. For example, the analysis may be available for hurricane, earthquake, tornado, hail, wildfire, flood hazards, etc. Users can access the AAL display 1800 by clicking on the AAL option in the drop down menu 1710 under the services icon tab. Once a user fills out the selected file to upload 1810, they can click an “Upload from EXCEL®” 1820 icon (or clear 1830 the form) and click a “Send” 1840 request icon. As a result, an AAL request grid 1850 will update with the information for the request that was sent to the platform (note that users may also filter and sort projects in the requests grid 1850). Due to the highly complex nature of calculating AAL requests, each request may typically take ten or more minutes to run. In some extreme cases when there are many concurrent users or users with large files, the system may take up to a half hour to return the answers. When the request is successfully completed, a download link under a results column in the grid 1850 may be enabled to let a user get the results as an EXCEL® sheet for the modeling metrics associated with the account.

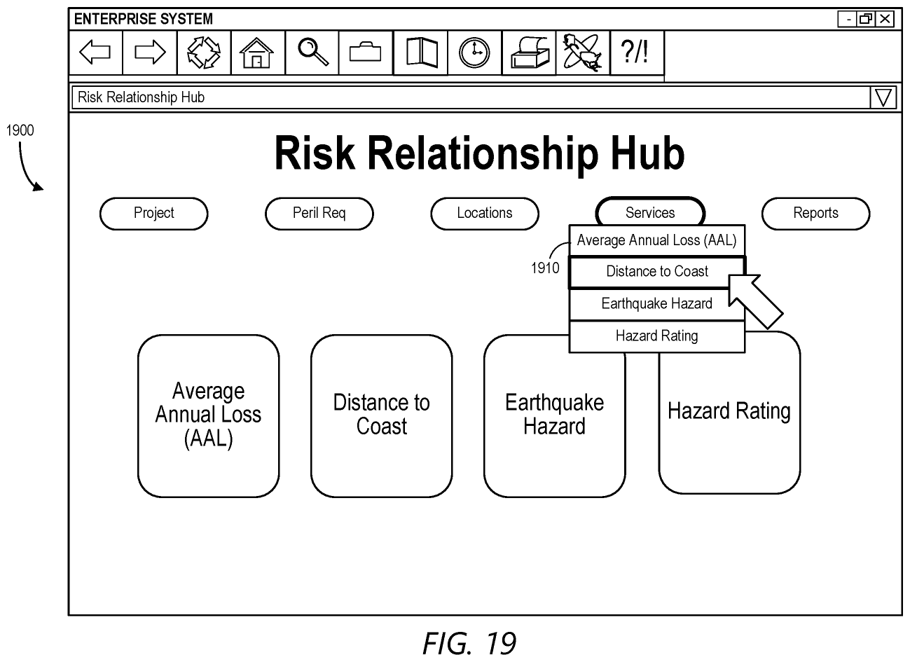

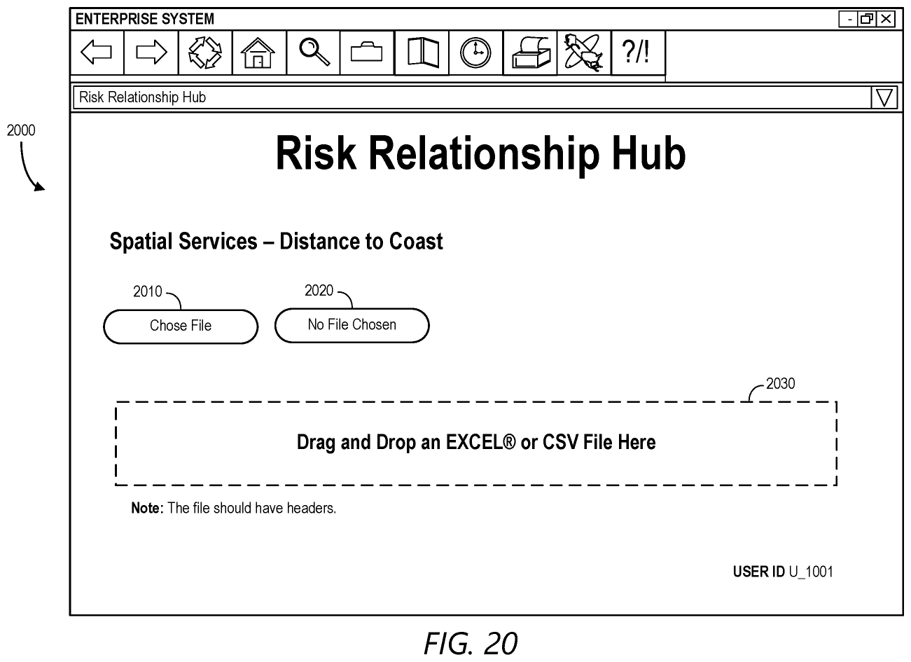

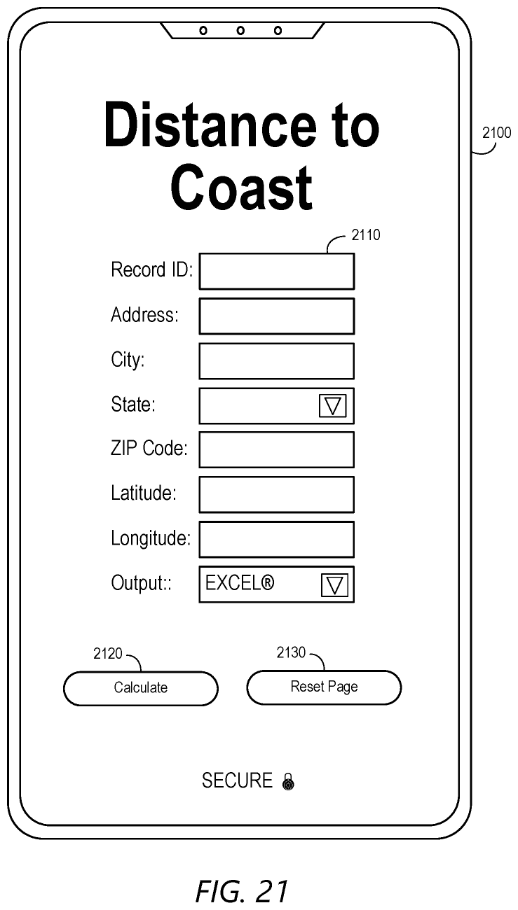

A distance to coast tool may let a user request information for a hurricane analysis based on a set of addresses within a spreadsheet. For example, FIG. 19 is a distance to coast selection display 1900 with a drop down menu 1910 according to some embodiments. Upon selection, a spatial services page may let a user enter information. For, example, FIG. 20 is a distance to coast data entry display 2000 in accordance with some embodiments. Here, a user can select a “Chose File” 2010 icon or indicate that there is “No File Chosen” 2020 icon. In some embodiments, a user can drag-and-drop a spreadsheet or Comma Separated Values (“CSV”) file with headers to an area 2030 to initiate an analysis. FIG. 21 is another distance to coast display 2100 on a smartphone that can be used to enter information 2110, calculate 2120 a result, or reset the page 2130 according to some embodiments. According to some embodiments, the distance to coast tool uses the same EXCEL® template as the earthquake hazard tool to let a user obtain metrics for both hurricane and earthquake risks without needing to create two separate input files.

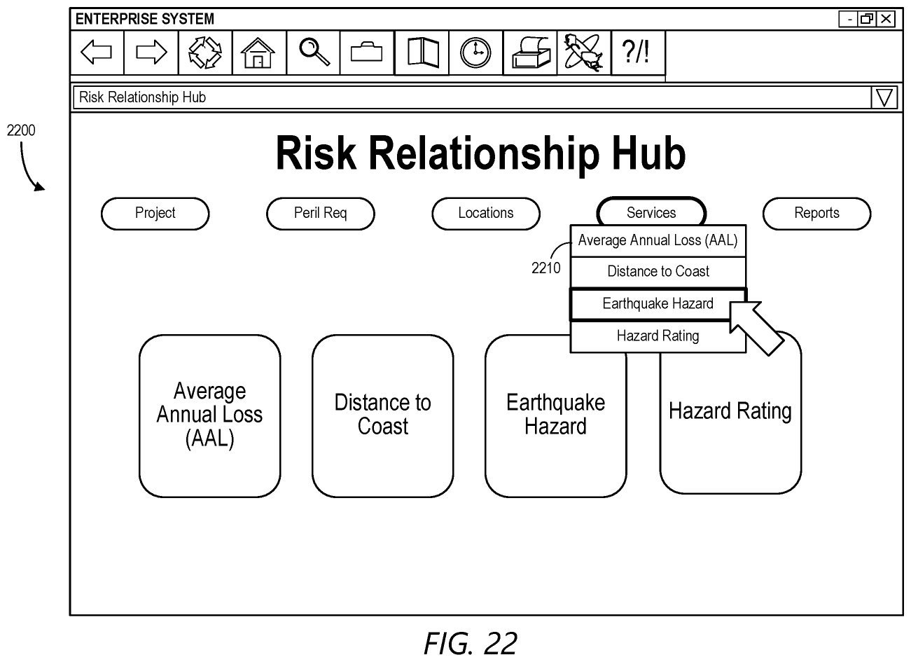

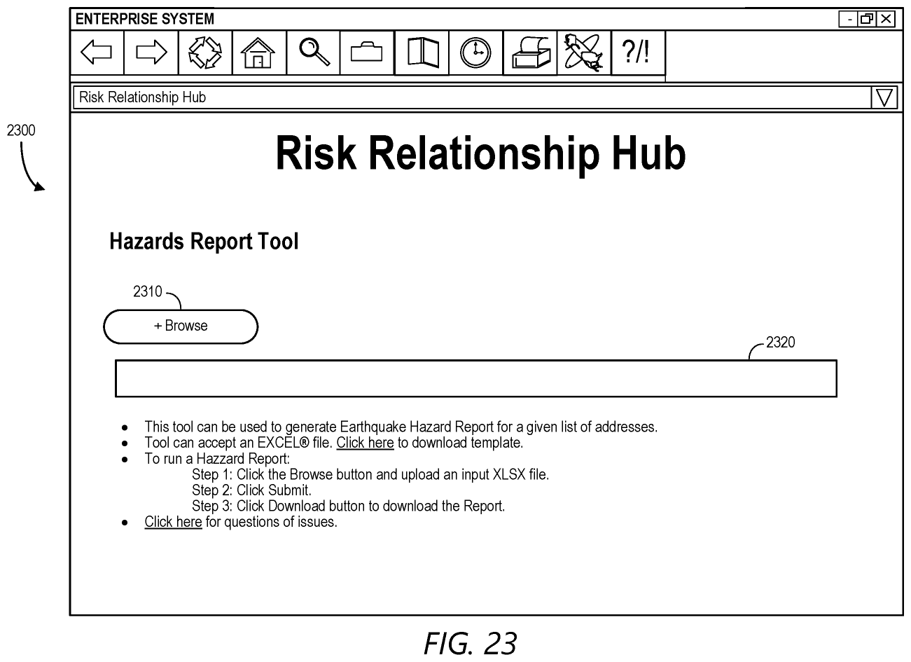

An earthquake hazard tool may also let a user request a hurricane analysis based on a set of addresses within a spreadsheet. For example, FIG. 22 is earthquake hazard selection display 2200 with a drop down menu 2210 according to some embodiments. Upon selection, an earthquake hazard report tool display 2300 such as the one shown in FIG. 23 may be provided according to some embodiments. The earthquake hazard tool lets a user request earthquake hazard information such as soil type, liquefaction information, Modified Mercalli Intensity (“MMI”) scale information, and a distance to a fault line for a set of addresses. The user may browse 2310 to a file with locations or enter the name 2320. The directions on how to run this request are noted on the bottom of the display 2300.

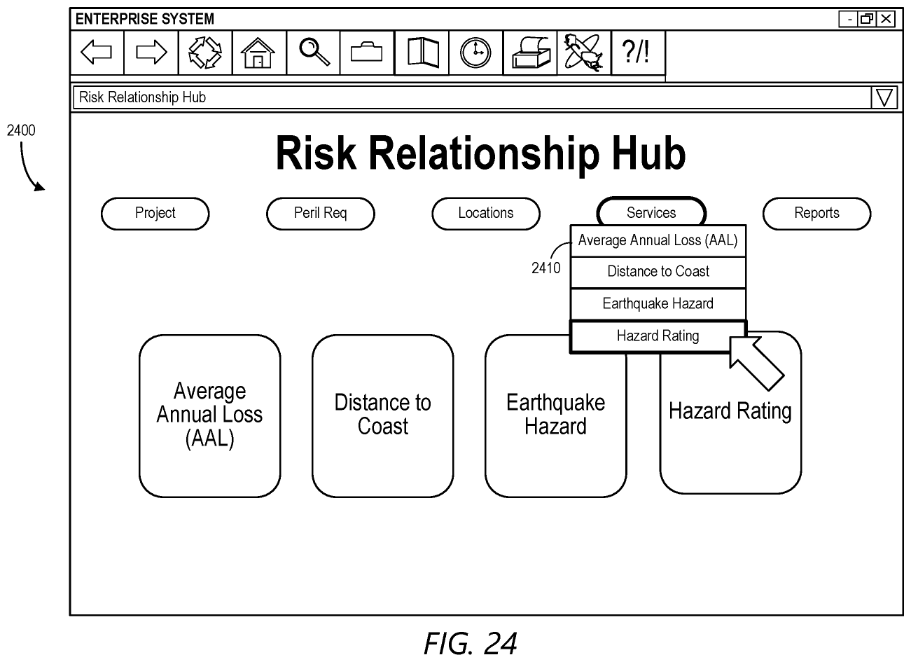

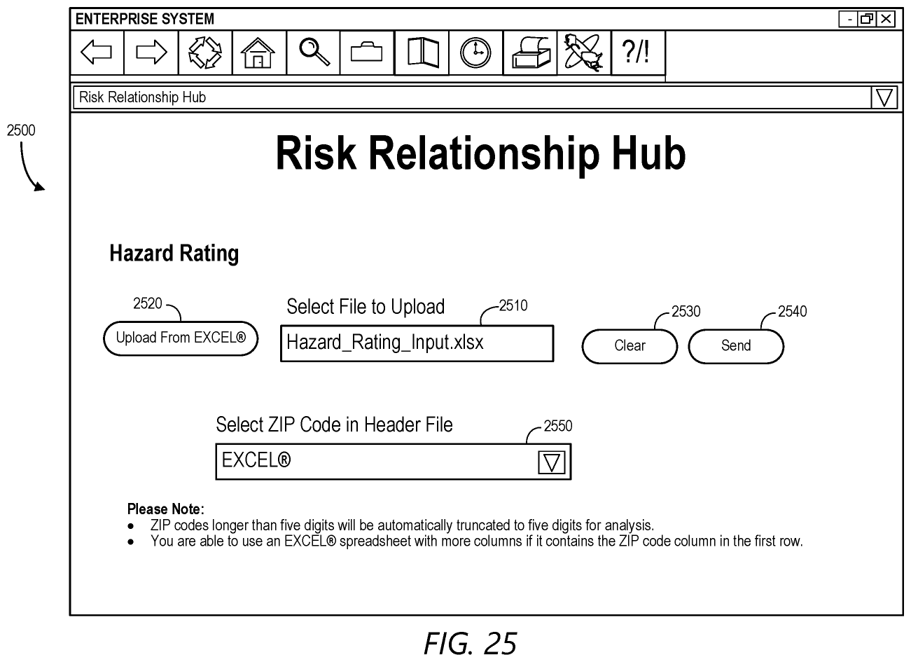

FIG. 24 is a hazard rating selection display 2400 with a drop down menu 2410 in accordance with some embodiments. Upon selection, a hazard rating display 2500 such as the one shown in FIG. 25 may be provided according to some embodiments. The display 2500 may let a user select a file to upload 2510, upload from EXCEL® 2520 (e.g., using a file with a ZIP code column selects via drop down menu 2550), clear 2530 the page, and/or send 2540 a request to the tool. The tool may then return a set of hazard scores and descriptions for hurricane, earthquake, tornado, hail and winter storm perils (e.g., very low, low, moderate, moderate/high, high, very high, extreme, etc.).

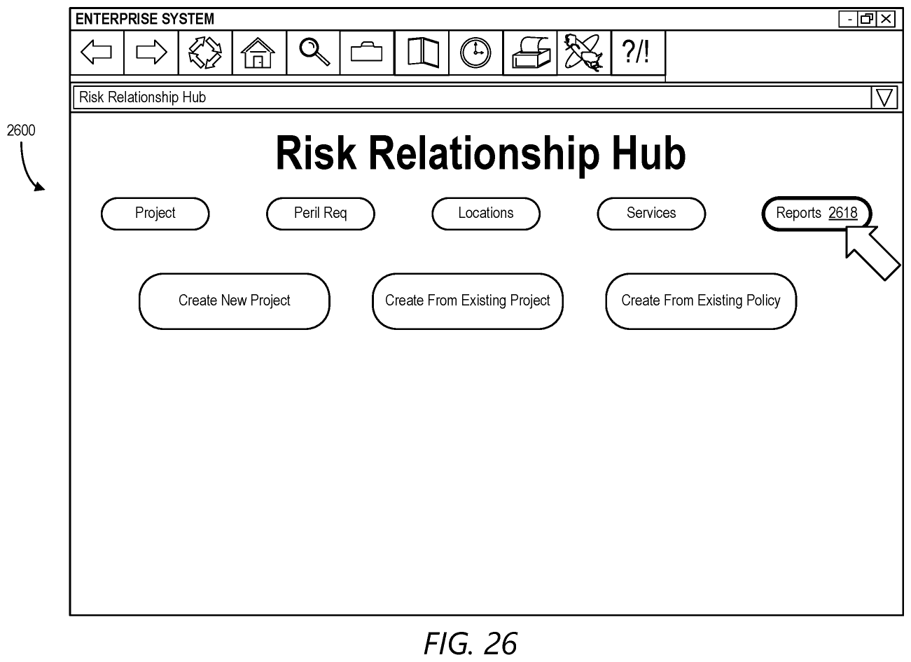

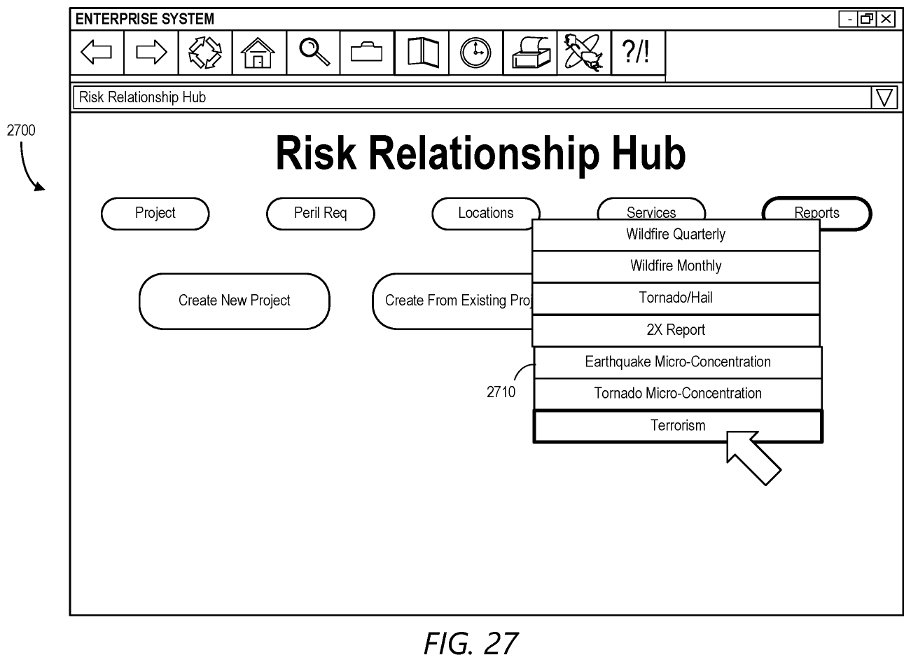

FIG. 26 is an exposure reports 2618 selection display 2600 in accordance with some embodiments. When a user selects exposure reports 2618, a variety of reports choices may be made available. An insurance risk team within enterprise risk management may, according to some embodiments, publish reports that highlight concentrations of risk by type of peril. For example, FIG. 27 is an exposure report drop down menu 2710 display 2700 according to some embodiments. A wildfire quarterly report might focus on exposure concentrations of extreme tail wildfire events in the western US. The report may also break down high risk exposure concentration into hazard zones and mile-by-mile grids. Similarly, a wildfire monthly report may provide a pared down version of the wildfire quarterly report showing only exposure concentration by hazard zone.

A tornado/hail report may provide a view of exposure, market share, and/or relative market share for each defined hail and tornado hazard zone by state and line of business. The menu 2710 may also include a 2X report that shows the top ZIP codes by Total Replacement Value (“TRV”) where the enterprise ZIP code market share is greater than or equal to two times the enterprise state market share. An earthquake micro-concentration report may provide a view of loss and market share metrics by defined earthquake micro-concentration zones. Note that the result of a risk analysis may, according to some embodiments, be based on risk relationships between the enterprise and parties other than the selected party. For example, a micro-concentration analysis might consider the marginal impact that a potential new insurance policy and/or new client might have on an overall book of business/risk profile of an insurer. Similarly, a tornado micro-concentration may provide a view of tornado micro-concentration grids where a PML value (e.g., a 100-year PML value) is greater than a threshold amount. A terrorism report may be used to monitor enterprise exposure to countrywide terrorism targets defined as having a PML aggregation value greater than a threshold amount.

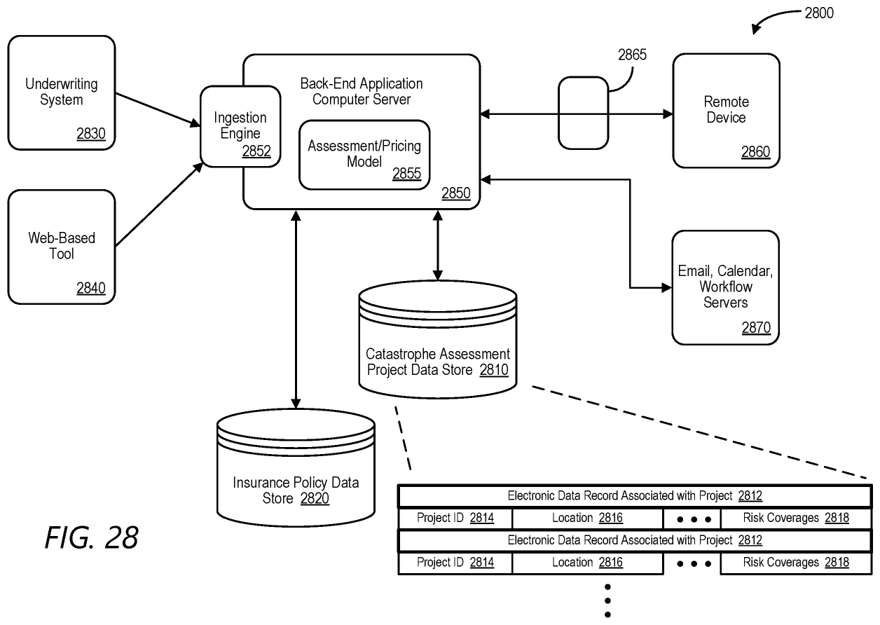

FIG. 28 is a more detailed system 2800 according to some embodiments. As before, the system 2800 includes a back-end application computer server 2850 that may access information in a catastrophe assessment project data store 2810 (e.g., storing a set of electronic records associated with catastrophe assessment projects 2812, each record including, for example, one or more project identifiers 2814, locations 2816, risk coverages 2818, etc.). The back-end application computer server 2850 may also store information into other data stores, such as insurance policy data store 2820, and utilize an ingestion engine 2852 and assessment/pricing model 2855 to exchange and process catastrophe risk changes (e.g., daily/weekly data sweeps or on-demand changes) and view, analyze, and/or update the electronic records based on information from an underwriting system 2830, a web-based tool 2840, etc. The back-end application computer server 2850 may also exchange information with a remote device 2860 (e.g., via a firewall 2865). According to some embodiments, the back-end application computer server 2850 may interact with an email server (e.g., to automatically establish communication links and/or transmit electronic messages based on risk assessment results), a calendar server (e.g., to automatically schedule tasks or communications based on risk assessment results), and/or a workflow server 2870 (e.g., to initiate actions by employees or programs of the enterprise based on risk assessment results).

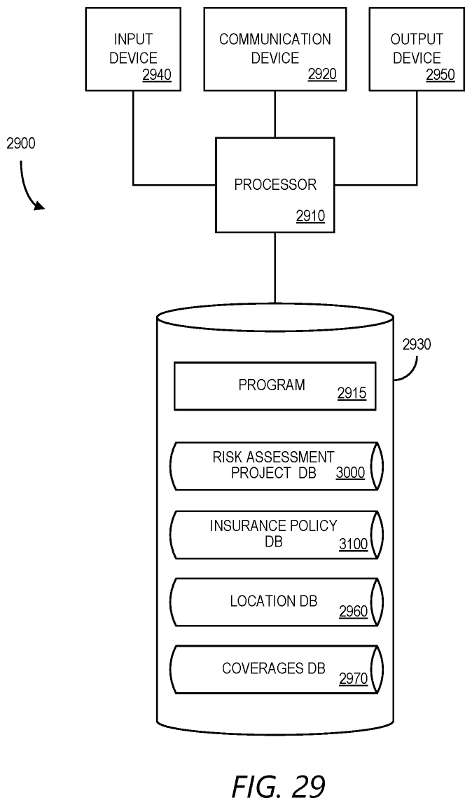

The embodiments described herein may be implemented using any number of different hardware configurations. For example, FIG. 29 illustrates an apparatus 2900 that may be, for example, associated with the systems 200, 2800 described with respect to FIGS. 2 and 28, respectively. The apparatus 2900 comprises a processor 2910, such as one or more commercially available Central Processing Units (“CPUs”) in the form of one-chip microprocessors, coupled to a communication device 2920 configured to communicate via a communication network (not shown in FIG. 29). The communication device 2920 may be used to communicate, for example, with one or more remote third-party devices, underwriting platforms, web-based tools, administrators, insurance agents, and/or communication devices (e.g., PCs and smartphones). Note that communications exchanged via the communication device 2920 may utilize security features, such as those between a public internet user and an internal network of an insurance company and/or an enterprise. The security features might be associated with, for example, web servers, firewalls, and/or PCI infrastructure. The apparatus 2900 further includes an input device 2940 (e.g., a mouse and/or keyboard to enter information about risk data sources, risk management rules or preferences, locations, etc.) and an output device 2950 (e.g., to output reports regarding risk management, machine learning algorithms, recommendations, alerts, etc.).

The processor 2910 also communicates with a storage device 2930. The storage device 2930 may comprise any appropriate information storage device, including combinations of magnetic storage devices (e.g., a hard disk drive), optical storage devices, mobile telephones, and/or semiconductor memory devices. The storage device 2930 stores a program 2915 and/or a risk management tool or application for controlling the processor 2910. The processor 2910 performs instructions of the program 2915, and thereby operates in accordance with any of the embodiments described herein. For example, the processor 2910 may associate a selected risk assessment project identifier with a selected party having a risk relationship with the enterprise. The processor 2910 may then receive from a user an adjustment to at least one of location and risk coverages associated with the selected risk assessment project identifier. A risk analysis is automatically performed based on the adjusted location and risk coverages (along with information retrieved from a risk relationship data store) and a result of the risk analysis can be updated.

The program 2915 may be stored in a compressed, uncompiled and/or encrypted format. The program 2915 may furthermore include other program elements, such as an operating system, a database management system, and/or device drivers used by the processor 2910 to interface with peripheral devices.

As used herein, information may be “received” by or “transmitted” to, for example: (i) the apparatus 2900 from another device; or (ii) a software application or module within the apparatus 2900 from another software application, module, or any other source.

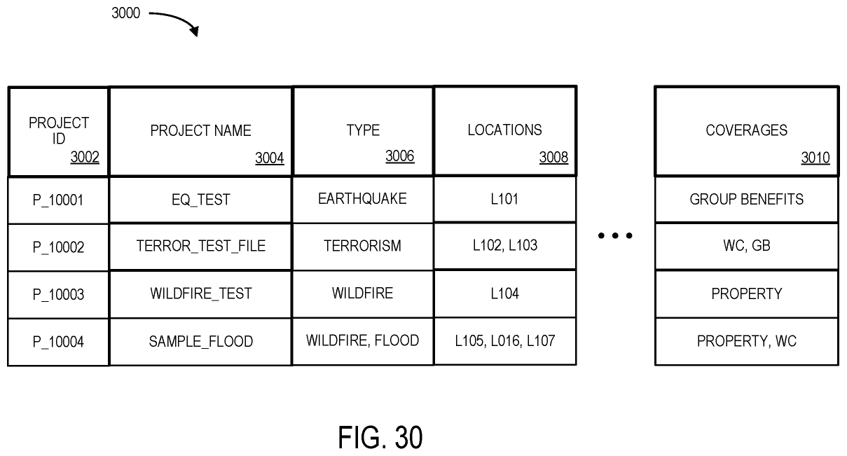

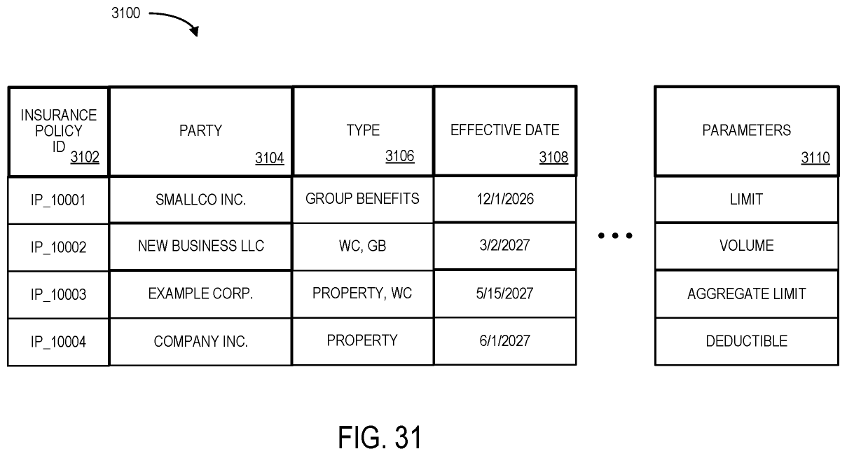

In some embodiments (such as shown in FIG. 29), the storage device 2930 further includes a risk assessment project database 3000, an insurance policy database 3100, a location database 2960, and an insurance coverages database 2970. Examples of databases that might be used in connection with the apparatus 2900 will now be described in detail with respect to FIGS. 30 and 31. Note that the databases described herein are only examples, and additional and/or different information may be stored therein. Moreover, various databases might be split or combined in accordance with any of the embodiments described herein. For example, the risk assessment project database 3000 and insurance policy database 3100 might be combined and/or linked to each other within the program 2915.

Referring to FIG. 30, a table is shown that represents the risk assessment project database 3000 that may be stored at the apparatus 2900 according to some embodiments. The table may include, for example, entries associated with different types of catastrophe assessment projects that may be used to manage risk information. The table may also define fields 3002, 3004, 3006, 3008, 3010 for each of the entries. The fields 3002, 3004, 3006, 3008, 3010 may, according to some embodiments, specify: a project identifier 3002, a project name 3004, a type 3006, locations 3008, and coverages 3010. The risk assessment project database 3000 may be created and updated, for example, based on information electrically received from various EXCEL® files or user adjustment (e.g., including when a new location is added or existing information about insurance coverage is adjusted) in connection with an insurer or business.

The project identifier 3002 may be, for example, a unique alphanumeric code identifying a type of catastrophe assessment project that is used to manage risk information. The project name 3004 may describe the project and the type 3006 may reflect the kinds of catastrophes that being investigated. The locations 3008 may be used, for example, to automatically calculate risk scores and the coverages 3010 may be used to determine a PML value associated with the project.

Referring to FIG. 31, a table is shown that represents the insurance policy database 3100 that may be stored at the apparatus 2900 according to some embodiments. The table may include, for example, parties that have a risk relationship with an enterprise. The table may also define fields 3102, 3104, 3106, 3108, 3110 for each of the entries. The fields 3102, 3104, 3106, 3108, 3110 may, according to some embodiments, specify: an insurance policy identifier 3102, a party 3104, a type 3106, an effective date 3108, and parameters 3110. The insurance policy database 3100 may be created and updated, for example, based on information electrically received from an enterprise platform or insurance agent.

The insurance policy identifier 3102 may be, for example, a unique alphanumeric code identifying an existing insurance policy, an insurance policy undergoing a renewal process, a potential future insurance policy (e.g., during an underwriting process), etc. The party 3104 (e.g., a business) represents an entity that has a risk relationship with an enterprise (e.g., an insurance company). The type 3106 may reflect the areas of insurance coverage that are being considered (e.g., group benefits, workers' compensation, property, etc.) and the effective date 3108 may indicate when the policy is in effect. The parameters 3110 may indicate the details of the insurance relationship such as limit values, volume amounts, deductibles, etc.

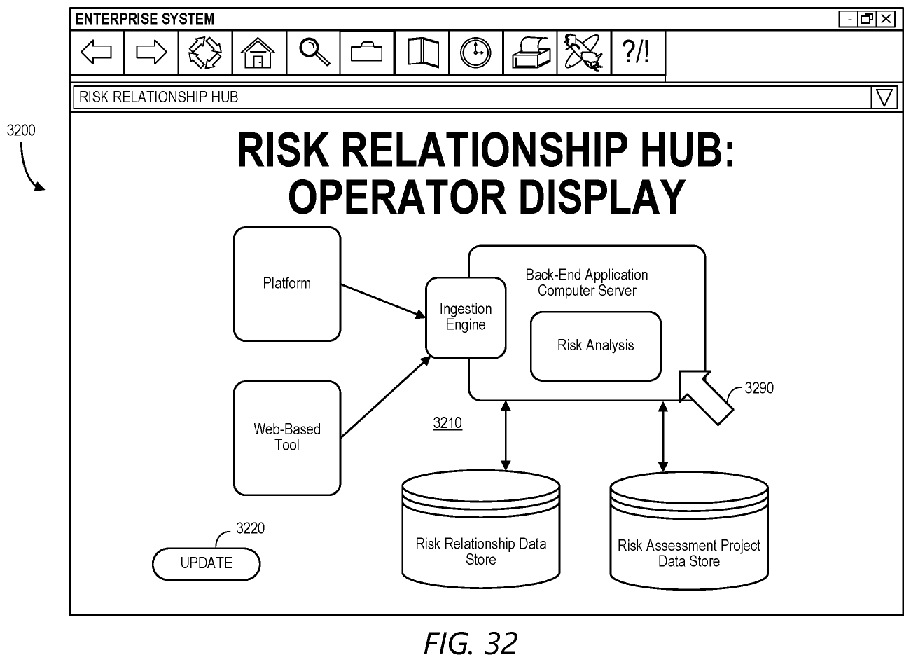

The operation of the risk relationship hub may be controlled via a Graphical User Interface (“GUI”). For example, FIG. 32 is a risk management operator or administrator display 3200 including graphical representations of elements of such a tool 3210 according to some embodiments. Selection of a portion or element of the display 3200 via a touchscreen or pointer 3290 might result in the presentation of additional information about that portion or element (e.g., a popup window presenting a data source or hazard analysis details) or let an operator or administrator enter or annotate additional information about analysis rules (e.g., based on his or her experience and expertise). An “Update” icon 3220 might initiate a risk management process.

Thus, embodiments may provide a risk management tool to enhance catastrophe risk management capabilities via an innovative, independent software architecture facilitating upgrades of many different risk assessment tools and pricing services without disrupting the underwriting process. These capabilities may be designed to be leveraged across multiple underwriting platforms to ensure consistency in the assessment of catastrophe risk across an enterprise. According to some embodiments, the hub can be accessed through a web browser to leverage the existing services built to provide real-time catastrophe pricing, hazard assessment, and marginal impacts on concentration to the underwriters. It also helps compare new insurance policies to existing policies in the same geographic area to assess net value-add to a portfolio.

According to some embodiments, the hub platform offers integrated risk services including account loss modeling and hazard assessment in addition to portfolio level reporting capabilities to monitor portfolio characteristics. Additionally, the hub may act as a data warehouse to store location level details of group benefits and national account workers' compensation policies used for enterprise aggregation management associated with terrorism, earthquake, and workplace incidents

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to specific types of entities, embodiments may instead be associated with other types of businesses in additional to and/or instead of those described herein. Similarly, although certain types of insurance, businesses, and coverage parameters were described in connection some embodiments herein, other types of insurance products and/or parameters might be used instead.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

What is claimed:

1. A risk management system implemented via a back-end application computer server of an enterprise, comprising:
(a) a risk assessment project data store that contains electronic records associated with a plurality of risk assessment project identifiers, and, for each risk assessment project identifier, a party identifier, a location, and associated risk coverages;
(b) a risk relationship data store that contains electronic records associated with a plurality of parties having risk relationships with the enterprise, and, for each party, a party identifier and risk relationship parameters;
(c) the back-end application computer server, coupled to the risk assessment project data store and the risk relationship data store, including:
a computer processor, and
a computer memory coupled to the computer processor and storing instructions that, when executed by the computer processor, cause the back-end application computer server to:
associate a selected risk assessment project identifier in the risk assessment project data store with a selected party having a risk relationship with the enterprise,
receive from a user an adjustment to at least one of the location and risk coverages associated with the selected risk assessment project identifier,
automatically perform a risk analysis based on the adjusted location and risk coverages along with information retrieved from the risk relationship data store in accordance with the party identifier of the selected party, and
update the risk assessment project data store with a result of the risk analysis; and
(d) a communication port coupled to the back-end application computer server to facilitate an exchange of data with a remote device to support interactive user interface displays that include information about the result of the risk analysis.

2. The system of claim 1, wherein the risk assessment project data store includes a plurality of locations for a single party identifier.

3. The system of claim 1, wherein the back-end application computer server receives information from at least one of an underwriting platform and a web-based tool via a modular architecture.

4. The system of claim 1, wherein the risk relationship between the selected party and the enterprise comprises catastrophe insurance.

5. The system of claim 4, wherein the catastrophe insurance is associated with at least one of: (i) terrorism, (ii) wildfires, (iii) earthquakes, (iv) hurricanes, (v) tornados and hail, (vi) winter storms, (vii) floods, (viii) landslides, (ix) sink holes, and (x) volcanos.

6. The system of claim 4, wherein the risk analysis is associated with at least one of a hazard assessment and a pricing model.

7. The system of claim 4, wherein the risk analysis may further be based on information from a spreadsheet application file.

8. The system of claim 4, wherein said automatic performance of the risk analysis generates multiple results, each result being associated with a different type of risk.

9. The system of claim 4, wherein the result of the risk analysis is further based on risk relationships between the enterprise and parties other than the selected party.

10. The system of claim 4, wherein the risk coverages are associated with at least one of: (i) a property insurance policy, (ii) a workers' compensation insurance policy, and (iii) a group benefits insurance policy.

11. The system of claim 10, wherein the risk coverages include at least one of: (i) an aggregate limit value, (ii) an aggregate deductible value, and (iii) volume values.

12. The system of claim 4, wherein the result of the risk analysis includes at least one of: (i) an average annual loss, (ii) a distance to coast, (iii) a hazard rating, and (iv) a hazard exposure report.

13. A risk management method implemented via a back-end application computer server of an enterprise, comprising:
associating, by a computer processor of the back-end application computer server, a selected risk assessment project identifier in a risk assessment project data store with a selected party having a risk relationship with the enterprise, wherein the risk assessment project data store contains electronic records associated with a plurality of risk assessment project identifiers, and, for each risk assessment project identifier, a party identifier, a location, and associated risk coverages;
receiving from a user an adjustment to at least one of the location and risk coverages associated with the selected risk assessment project identifier;
automatically performing a risk analysis based on the adjusted location and risk coverages along with information retrieved from the risk relationship data store in accordance with the party identifier of the selected party, wherein the risk relationship data store contains electronic records associated with a plurality of parties having risk relationships with the enterprise, and, for each party, a party identifier and risk relationship parameters;
updating the risk assessment project data store with a result of the risk analysis; and
exchanging data with a remote device to support interactive user interface displays that include information about the result of the risk analysis.

14. The method of claim 13, wherein the risk assessment project data store includes a plurality of locations for a single party identifier.

15. The method of claim 13, wherein the back-end application computer server receives information from at least one of an underwriting platform and a web-based tool via a modular architecture.

16. The method of claim 13, wherein the risk relationship between the selected party and the enterprise comprises catastrophe insurance.

17. A non-transitory, computer-readable medium storing instructions, that, when executed by a processor, cause the processor to perform a risk management method implemented via a back-end application computer server of an enterprise, the method comprising:
associating, by a computer processor of the back-end application computer server, a selected risk assessment project identifier in a risk assessment project data store with a selected party having a risk relationship with the enterprise, wherein the risk assessment project data store contains electronic records associated with a plurality of risk assessment project identifiers, and, for each risk assessment project identifier, a party identifier, a location, and associated risk coverages;
receiving from a user an adjustment to at least one of the location and risk coverages associated with the selected risk assessment project identifier;
automatically performing a risk analysis based on the adjusted location and risk coverages along with information retrieved from the risk relationship data store in accordance with the party identifier of the selected party, wherein the risk relationship data store contains electronic records associated with a plurality of parties having risk relationships with the enterprise, and, for each party, a party identifier and risk relationship parameters;
updating the risk assessment project data store with a result of the risk analysis; and
exchanging data with a remote device to support interactive user interface displays that include information about the result of the risk analysis.

18. The medium of claim 17, wherein the risk relationship between the selected party and the enterprise comprises catastrophe insurance.

19. The medium of claim 18, wherein the catastrophe insurance is associated with at least one of: (i) terrorism, (ii) wildfires, (iii) earthquakes, (iv) hurricanes, (v) tornados and hail, (vi) winter storms, (vii) floods, (viii) landslides, (ix) sink holes, and (x) volcanos.

20. The medium of claim 18, wherein the risk analysis is associated with at least one of a hazard assessment and a pricing model.

21. The medium of claim 18, wherein the risk coverages are associated with at least one of: (i) a property insurance policy, (ii) a workers' compensation insurance policy, and (iii) a group benefits insurance policy.

22. The medium of claim 21, wherein the risk coverages include at least one of: (i) an aggregate limit value, (ii) an aggregate deductible value, and (iii) volume values.

23. The medium of claim 18, wherein the result of the risk analysis includes at least one of: (i) an average annual loss, (ii) a distance to coast, (iii) a hazard rating, and (iv) a hazard exposure report.
